(19) United States
(12) Patent Application Publication
(10) Pub. No.: US 2026/0359722 A1
(43) Pub. Date: Nov. 12, 2026

(54) INFORMATION PROCESSING SYSTEM AND COMPUTER READABLE MEDIA

(71) Applicant: Sony Group Corporation, Tokyo (JP)

(72) Inventors: Sho NISHIDA, Tokyo (JP); Kenta ENDO, Tokyo (JP)

(73) Assignee: Sony Group Corporation, Tokyo (JP)

(21) Appl. No.: 19/482,255

(22) PCT Filed: Jun. 4, 2024
(86) PCT No.: PCT/JP2024/020290

§ 371 Date: Nov. 7, 2025

(30) Foreign Application Priority Data
Jun. 14, 2023 (JP) 2023-097401

(51) Int. Cl. G06N 20/00

(52) U.S. Cl. CPC G06N 20/00

(57) ABSTRACT

A system includes circuitry configured to receive a request for target data from a terminal device, the request including parameters specifying one or more desired data conditions, in response to the request for target data, generate, from a first database storing metadata corresponding to authenticated training data, options for a training data set based on the target data, transmit the options for the training data set to the terminal device, receive a request from the terminal device to access a training data set from the options for the training data set, in response to the request to access the training data set, create a non-fungible token (NFT) for a data address of the metadata corresponding to the training data set, transmit the NFT to the terminal device, and receive, from a server, a trained machine learning model based on the training data set indicated by the NFT.

### TECHNICAL FIELD

The present disclosure relates to an information processing system and one or more computer readable media.

### BACKGROUND ART

Conventionally, a technique for generating an artificial intelligence (AI) model for image recognition by machine learning with deep learning or the like using image data as training data is known.

On the other hand, in recent years, companies and the like are strongly required to pay attention to protection of personal information to be acquired. This does not exclude personal information included in the training data, and it is necessary to strongly pay attention to the protection thereof also in machine learning.

In order to meet this necessity, for example, a technology has been proposed for using image data as training data only if use consent of an imaging subject being photographed has been obtained for use the image data, and processing or deleting image data so as to be anonymized if consent of the subject has not been obtained.

### CITATION LIST

### Patent Literature

PTL 1: International Publication WO 2018/142764 A

### SUMMARY OF INVENTION

### Technical Problem

However, in the conventional technology, there is still room for further improvement in enabling cross-sectional utilization of training data including personal information while further protecting the personal information.

For example, the above-described conventional technique is merely for using, as training data, image data only if the use consent of the imaging subject has been obtained for use. Digital data may be easily leaked from a database or a communication network. Therefore, in a case where the above-described conventional technology is used, personal information cannot be completely protected in training data on a database or a communication network.

On the other hand, since the characteristics and tendencies indicated by the personal information are highly likely to greatly improve the prediction accuracy of the AI model, the training data including the personal information is very useful. However, there is an actual situation that requires a large amount of cost in terms of work and time to collect training data under a desired condition. Therefore, it is desirable that the training data including the personal information can be cross-sectionally utilized across users such as AI development vendors, for example, who use data.

Therefore, the present disclosure proposes an information processing system and one or more computer readable media that enable cross-sectional utilization of training data while further protecting personal information.

### Solution to Problem

In order to solve the above problems, one aspect of an information processing system according to the present disclosure is an information processing system including first circuitry configured to receive a request for target data from a terminal device, the request for the target data including parameters specifying one or more desired data conditions, in response to the request for target data, generate, from a first database storing metadata corresponding to authenticated training data, options for a training data set based on the target data, transmit the options for the training data set to the terminal device, receive a request from the terminal device to access a training data set from the options for the training data set, in response to the request to access the training data set, create a non-fungible token for a data address of the metadata corresponding to the training data set, transmit the non-fungible token to the terminal device, and receive, from a server, a trained machine learning model based on the training data set indicated by the non-fungible token.

### BRIEF DESCRIPTION OF DRAWINGS

FIG. 1 is an explanatory diagram of an edge sensor according to an embodiment of the present disclosure.

FIG. 2 is a conceptual diagram of a transaction system according to an embodiment of the present disclosure.

FIG. 3 is a schematic explanatory diagram of a transaction method according to an embodiment of the present disclosure.

FIG. 4 is a diagram (part 1) illustrating a configuration example and a data sequence of the transaction system according to an embodiment of the present disclosure.

FIG. 5 is a diagram (part 2) illustrating a configuration example and a data sequence of the transaction system according to an embodiment of the present disclosure.

FIG. 6 is a diagram illustrating an example of designation parameters of a desired data condition.

FIG. 7 is a diagram illustrating an example of the desired data condition.

FIG. 8 is a block diagram illustrating a configuration example of a transaction management device according to an embodiment of the present disclosure.

FIG. 9 is a diagram illustrating an example of determination details in an authentication process.

FIG. 10 is a block diagram illustrating a configuration example of a data-holding device according to an embodiment of the present disclosure.

FIG. 11 is a diagram illustrating a processing sequence from a transaction management request to a transaction management start.

FIG. 12 is a diagram illustrating a processing sequence from presentation of a desired data condition to provision of a trained AI model.

FIG. 13 is a diagram illustrating an example of a GUI screen that presents arrangement information.

FIG. 14 is a diagram illustrating a processing sequence in a case of executing machine learning sequentially across a plurality of data providers.

FIG. 15 is a diagram illustrating a processing sequence in a case of obtaining confirmation of the data-holding device.

FIG. 16 is a diagram illustrating a processing sequence in a case of performing retraining based on an improvement request from an end user.

FIG. 17 is a diagram illustrating a processing sequence in a case of trading a direct right to use of data.

FIG. 18 is a hardware configuration diagram illustrating an example of a computer that implements functions of the transaction management device.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

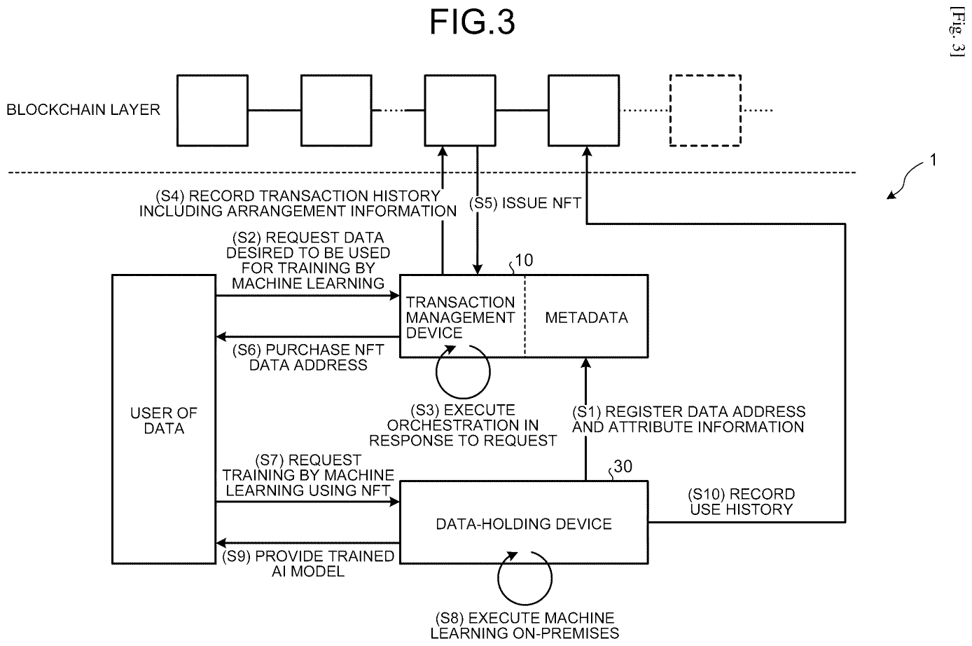

In addition, hereinafter, it is assumed that an information processing system according to an embodiment (hereinafter, appropriately referred to as the “present embodiment”) of the present disclosure is a transaction system 1 illustrated in FIG. 2 and subsequent drawings. In addition, a transaction management unit according to the present embodiment is assumed to be a transaction management device 10 illustrated in FIG. 2 and subsequent drawings. Further, a data-holding unit according to the present embodiment is assumed to be a data-holding device 30 illustrated in FIG. 3 and subsequent drawings. Furthermore, it is assumed that the information processing method according to the present embodiment is a transaction method executed by the transaction system 1.

In addition, hereinafter, the “AI model” may be replaced with a “machine learning model”.

Further, the present disclosure will be described according to the following order of items.
1. Overview
1-1. Edge Sensor According to Embodiment of Present Disclosure
1-2. Concept of Transaction System According to Embodiment of Present Disclosure
1-3. Outline of Transaction Method According to Embodiment of Present Disclosure
2. Configuration Example of Transaction System
3. Configuration Example of Transaction Management Device
4. Configuration Example of Data-Holding Device
5. Processing Sequence Executed by Transaction System
5-1. Processing Sequence from Transaction Management Request to Transaction Management Start
5-2. Processing Sequence from Presentation of Desired Data Condition to Provision of Trained AI Model
5-3. Processing Sequence for Case of Executing Machine Learning Sequentially Across Plurality of Data Providers
5-4. Processing Sequence for Case of Obtaining Confirmation of Data-Holding Device
5-5. Processing Sequence for Case of Performing Retraining based on Improvement Request from End User
5-6. Processing Sequence for Case of Trading Direct Right to Use of Data
6. Modification
7. Hardware Configuration
8. Conclusion

### 1. Overview

### 1-1. Edge Sensor According to Embodiment of Present Disclosure

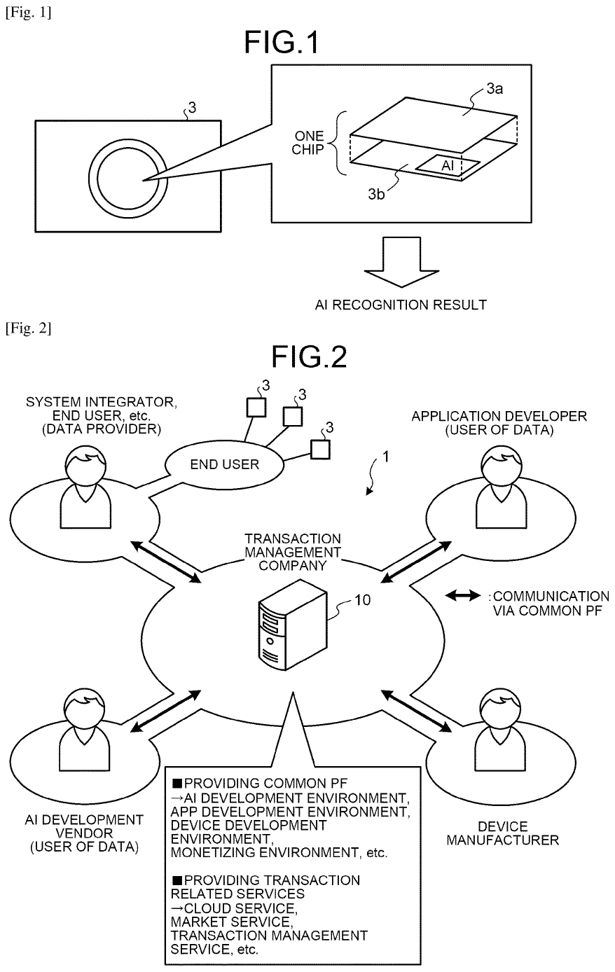

An outline of the present embodiment will be described. First, FIG. 1 is an explanatory diagram of an edge sensor 3 according to an embodiment of the present disclosure. In the present embodiment, it is assumed that an object to be a transaction target in the transaction system 1 is basically not an entity of image data serving as training data of machine learning but a right to use of training data.

In addition, this right to use is basically a right to use that indirectly uses training data instead of directly using the training data. It is assumed that the edge sensor 3 illustrated in FIG. 1 captures the image data to be the training data, for example.

As illustrated in FIG. 1, in the edge sensor 3, an imaging element unit 3a and a processor unit 3b are configured by one chip, and an AI model is mounted in an internal memory of the processor unit 3b (see “AI” in the drawing).

The edge sensor 3 is provided in, for example, various facilities such as a store of an end user, and various environments, such as in a vehicle and on a street. Then, the edge sensor 3 captures image data in an imaging target range in each environment provided, performs image recognition on the image data by the AI model, and outputs an AI recognition result. In this manner, the image data and the metadata including the recognition result accompanying the image data may be output, or only the image data or the metadata including the recognition result may be output.

By using the edge sensor 3, the AI recognition by edge computing becomes possible, and it is possible to reduce problems of delay and high load occurring in so-called centralized data processing. That is, the edge sensor 3 can be applied with high affinity to a paradigm shift to decentralized data processing caused by so-called Internet of Things (IoT) or the Web 3.0.

As described above, the edge sensor 3 is provided in various environments, and for this reason, the AI model mounted on each edge sensor 3 is required to have accuracy corresponding to the environment of each edge sensor 3. In addition, the AI model has a problem that “drift” occurs due to, for example, the lapse of time or a change in trend desired by the end user. The drift indicates that the prediction performance of the AI model deteriorates due to some “unexpected change”. Note that the drift includes “concept drift” in a case where the relationship between the input data and a ground-truth label (how to interpret the data) changes as compared with that at the time of model learning, “data drift” in a case where the nature of the input data itself (statistical distribution or the like) changes, and the like.

Therefore, it is desirable that the AI model is trained or retrained on the basis of a data set of high-quality training data according to the characteristics and environment of the edge sensor 3 and finely tuned as appropriate. In addition, the characteristics and tendencies indicated by the personal information included in the training data are highly likely to greatly improve the prediction accuracy of the AI model, and are very useful. Therefore, it is very desirable that users of data such as AI development vendors can easily obtain training data including the personal information at any time.

However, regardless of the presence or absence of personal information, there is an actual situation that requires a large amount of cost in terms of work and time to collect training data under a desired condition. The transaction method according to the present embodiment is to cross-sectionally utilize training data among users of data on the premise of such an actual situation.

In addition, the transaction method according to the present embodiment is also in consideration of the protection of personal information, and only a data holder who is a party that has obtained the use consent of the imaging subject and holds image data to be training data manages the entity of the data on-premises. Meanwhile, the data holder can also be a data provider that provides data held by the data holder to the user of data. As a data provider, the data holder provides the above-described right to use instead of the entity of the data held by the data holder. The transaction system 1 according to the present embodiment is a system that performs a transaction while managing the right to use of the data as a transaction target.

### 1-2. Concept of Transaction System According to Embodiment of Present Disclosure

FIG. 2 is a conceptual diagram of the transaction system 1 according to an embodiment of the present disclosure. The transaction system 1 includes the transaction management device 10 managed and operated by a transaction management company. The transaction management device 10 provides a common platform (hereinafter, appropriately abbreviated as “common PF”) to the parties involved in a system integration service using the edge sensor 3.

As illustrated in FIG. 2, the party mentioned here is a “data provider” who is a system integrator, an end user, or the like, a “user of data” who is an AI development vendor, an application developer, or a device manufacturer who is a device developer of the edge sensor 3.

The transaction management device 10 provides, for example, an AI development environment as a common PF to a system integrator as a data provider and an AI development vendor as a user of data. In addition, the transaction management device 10 provides the application developer with, for example, an app (application) development environment as a common PF. In addition, the transaction management device 10 provides the device manufacturer with, for example, a device development environment as a common PF. In addition, the transaction management device 10 provides each party with, for example, a monetizing environment as a common PF.

Then, in particular, the transaction management device 10 provides a transaction related service of training data in the transaction system 1. Examples of the transaction related service include a cloud service, a market service, and a transaction management service.

The cloud service is, for example, a GUI service or the like that provides a graphical user interface (GUI) screen or the like for a user of data when purchasing training data. The market service is a service for providing a market as an electronic market trading a right to use of training data provided as a transaction target from a data provider. The transaction management service is a service that manages a transaction history, a use history, and the like of training data.

As described above, the transaction system 1 illustrated as a conceptual diagram in FIG. 2 executes the transaction method according to the present embodiment as illustrated in FIG. 3 in order to enable cross-sectional utilization of training data including personal information while further protecting the personal information.

### 1-3. Outline of Transaction Method According to Embodiment of Present Disclosure

FIG. 3 is a schematic explanatory diagram of the transaction method according to an embodiment of the present disclosure. As illustrated as a blockchain layer in FIG. 3, the transaction system 1 according to the present embodiment performs transaction management using a known blockchain that functions as a decentralized ledger in a decentralized network.

In the present embodiment, for example, a blockchain is generated for each training data to be a transaction target, and each block is connected in time series with a block to which an identifier uniquely indicating the training data is input as an origin block. Each block records a history or the like regarding transactions with respect to the transaction target. The history regarding the transaction includes a transaction history and a use history of the corresponding training data.

The input data to each block is encrypted to a hash value by a predetermined hash algorithm. In addition, each block stores a hash value of an address of a previous block. Therefore, it is almost impossible for a person other than a participant in the decentralized network to falsify the input data of each block or retroactively change the connection of the blocks. Using this blockchain is a part of protecting the personal information described above.

In addition, the transaction system 1 includes a transaction management device 10 and a data-holding device 30. The data-holding device 30 is a device managed and operated by the above-described data provider. The data-holding device 30 holds an image data group captured by the edge sensor 3 and a recognized AI recognition result group. The AI recognition result group may use a result obtained by performing AI recognition processing on image data captured by the edge sensor 3 at a place other than the edge sensor 3. Data held by the data-holding device 30 can be registered in the transaction management device 10 as a transaction target in the transaction system 1.

However, the data-holding device 30 registers not entity of data, but metadata including a data address that is a data storage destination and attribute information of data, with the transaction management device 10 (Step S1). That is, the transaction management device 10 manages the training data to be a transaction target not by the entity of the data but by the metadata as illustrated in FIG. 3.

Then, for example, the user of data who is an AI development vendor requests data desired to be used for training by machine learning from the transaction management device 10 through a GUI service or the like provided by the transaction management device 10 (Step S2). Then, the transaction management device 10 executes orchestration in response to the request in Step S2 for the metadata group managed by itself (Step S3).

The orchestration described herein indicates that the transaction management device 10 generates (“generate” may be replaced with “organize” or “arrange”) options for a training data set which is a combination of training data according to the request in Step S2 on the basis of the metadata group managed by itself. Note that, hereinafter, information corresponding to an execution result of the orchestration will be appropriately referred to as “arrangement information”.

Then, the transaction management device 10 records the transaction history including the arrangement information as the execution result of Step S3 on a blockchain (Step S4). As a result, a non-fungible token (NFT), which is a non-replaceable token, is issued from a blockchain layer (Step S5). Hereinafter, the operations in Step S4 to Step S5 will be appropriately referred to as “creating an NFT”. In other words, to create an NFT means non-replaceability in a decentralized network is imparted to metadata in response to a request from a user of data. The NFT certifies the indirect right to use of the previously stored data indicated by the data address in the metadata. Then, the user of data purchases the NFT data address (Step S6).

Subsequently, when the user of data requests the data-holding device 30 to perform training by machine learning using the purchased NFT (Step S7), the data-holding device 30 executes the machine learning on-premises using the data indicated by the NFT as training data (Step S8). That is, at this time, the entity of the training data used for machine learning is not transferred from the data-holding device 30 to the user side of data.

That is, the user of data uses the purchased training data only indirectly for machine learning. As a result, for example, it is possible to suppress a risk that a copy of the entity of the corresponding training data is transferred to the user side of data due to direct use of the data, and personal information included in the training data is spread from the user side of data. Note that the data-holding device 30 executes the machine learning of Step S8 using, for example, the machine learning engine included in the AI development environment provided as the above-described common PF from the transaction management device 10.

Then, after the execution of Step S8, the data-holding device 30 provides the user of data with a trained AI model that is an AI model trained by the training data (Step S9). In addition, the data-holding device 30 records the use history in Step S7 to Step S9 on the blockchain (Step S10). This use history includes, for example, a history indicating that the right to use for the user of data has been lost due to the end of use of the trained AI model provided.

Note that, although not illustrated in FIG. 3, the data-holding device 30 may verify the accuracy of the trained AI model. Furthermore, after the verification, the data-holding device 30 may provide only the trained AI model having a certain level of accuracy or more to the user of data. Furthermore, the data-holding device 30 may cause the transaction management device 10 to disclose a trained AI model having a certain level of accuracy or more to the market as a transaction target.

Furthermore, the data-holding device 30 may verify not only the accuracy of the trained AI model but also, for example, whether or not the trained AI model satisfies AI ethics. Furthermore, the subject who sets the criteria regarding verification of accuracy and AI ethics may be a data provider who manages and operates the data-holding device 30 or a transaction management company who manages and operates the transaction management device 10. Further, various policies and guidelines such as a privacy policy and a security policy defined in the market may be used as the reference.

Hereinafter, a configuration example of the transaction system 1 to which the transaction method according to the present embodiment is applied, the outline of which has been described with reference to FIG. 3, will be described more specifically.

### 2. Configuration Example of Transaction System

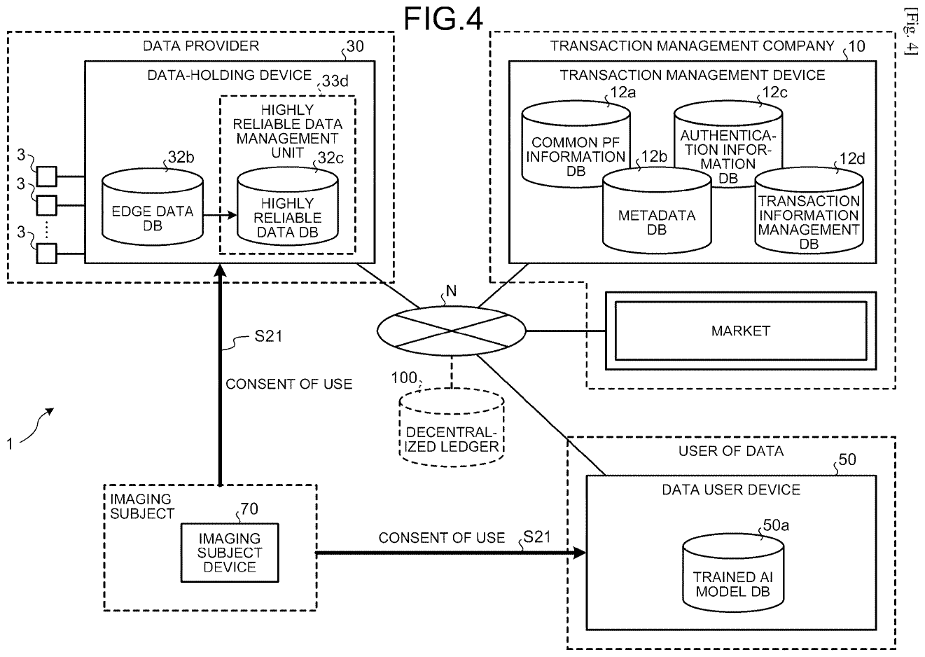

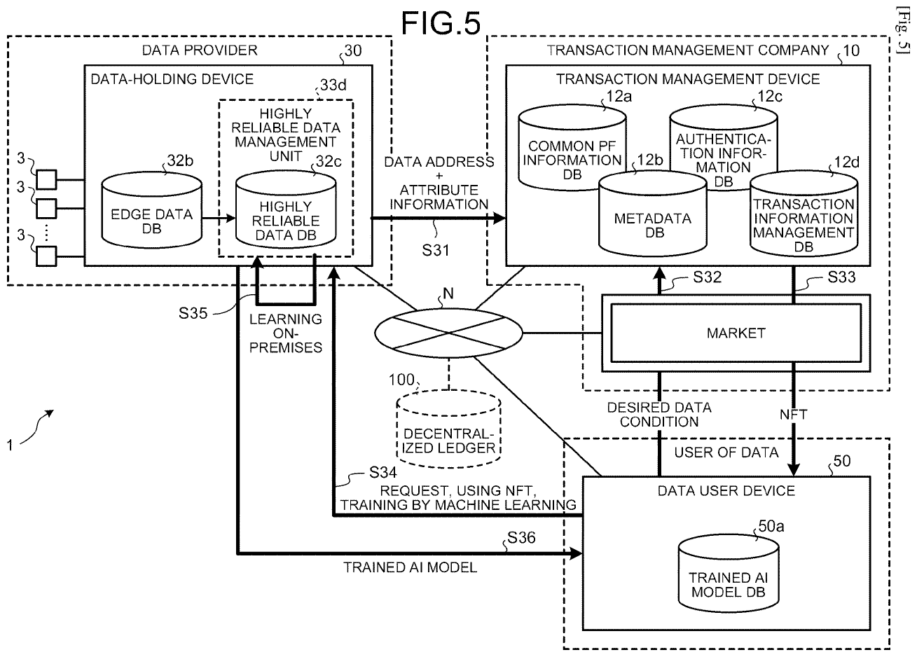

FIG. 4 is a diagram (part 1) illustrating a configuration example and a data sequence of the transaction system 1 according to an embodiment of the present disclosure. In addition, FIG. 5 is a diagram (part 2) illustrating a configuration example and a data sequence of the transaction system 1 according to an embodiment of the present disclosure.

As illustrated in FIG. 4, the transaction system 1 includes a transaction management device 10, a data-holding device 30, a data user device 50, and an imaging subject device 70.

As described above, the transaction management device 10 is a device managed and operated by a transaction management company. The data-holding device 30 is a device managed and operated by the data provider as described above. The data user device 50 is a device used by the user of data. The imaging subject device 70 is a device used by the subject captured in the image data by the edge sensor 3.

The transaction management device 10, the data-holding device 30, and the data user device 50 are connected via a decentralized network N by a peer to peer (P2P) network.

The transaction management device 10 includes a common PF information database (DB) 12a, a metadata DB 12b, an authentication information DB 12c, and a transaction information management DB 12d. The transaction management device 10 provides the common PF based on the common PF information stored in the common PF information DB to each device in the transaction system 1.

The metadata DB 12b stores metadata of data held by the data-holding device 30, which is provided by the data-holding device 30. Note that the transaction management device 10 handles highly reliable data with high reliability that has cleared a predetermined authentication condition among the data held by the data-holding device 30 as a transaction target. The authentication information DB 12c stores authentication information including various parameters related to the authentication condition.

The transaction information management DB 12d stores transaction information which is information regarding a transaction of each metadata which is authenticated as highly reliable data and handled as a transaction target among the metadata included in the metadata DB 12b. This transaction information is also recorded in the decentralized ledger in the decentralized network N as blockchain data. In addition, the transaction management device 10 provides the market described above. The market can target not only the right to use of training data but also, for example, a trained AI model trained using the right to use, for transaction.

One or more edge sensors 3 are connected to the data-holding device 30. The edge sensor 3 may be, for example, connected to the data-holding device 30 via a communication network conforming to a freely-selected standard such as a controller area network (CAN), a local interconnect network (LIN), or FlexRay (registered trademark) in addition to a wireless local area network (LAN) or a wired LAN.

Further, the data-holding device 30 includes an edge data DB 32b and a highly reliable data DB 32c. The edge data DB 32b stores edge data from each edge sensor 3. The edge data includes image data that is imaged data captured by the edge sensor 3 and an AI recognition result. Note that, as described above, in the present embodiment, the edge sensor 3 outputs the AI recognition result, but does not necessarily need to output the AI recognition result.

The highly reliable data DB 32c clears the authentication condition and stores the highly reliable data extracted from the edge data DB 32b. The highly reliable data includes entities of the edge data. The highly reliable data DB 32c is managed by a highly reliable data management unit 33d included in the data-holding device 30.

The data user device 50 is a terminal device used by the user of data, and is implemented by a personal computer (PC) or the like. The data user device 50 indirectly uses the highly reliable data stored in the highly reliable data DB 32c using the right to use purchased from the market, and acquires the trained AI model, which is the training result by the highly reliable data, from the highly reliable data management unit 33d. The data user device 50 includes a trained AI model DB 50a. The trained AI model DB 50a stores the trained AI model.

The imaging subject device 70 is a terminal device used by the subject, and is implemented by a smartphone, a tablet terminal, a PC, a wearable device, or the like. As illustrated in FIG. 4, the imaging subject device 70 gives a consent of use to the data-holding device 30 and the data user device 50.

For example, in a case where the data provider is an operating company of a convenience store, a privacy policy is presented to the imaging subject device 70. The privacy policy includes that the imaging subject is an imaging target of the edge sensor 3 via the app provided by the company and that the imaged data is used for machine learning.

Then, when the imaging subject agrees with the privacy policy presented to the imaging subject device 70 and shows his/her consent via the app, the imaging subject device 70 transmits the consent of use to the data-holding device 30 and the data user device 50 (Step S21).

Then, the data-holding device 30 associates the fact that the agreement has been obtained as one piece of attribute information for the edge data in the case where the agreement has been obtained. On the other hand, for edge data in a case where agreement has not been obtained, information indicating that agreement has not been obtained is associated as one piece of attribute information. When the highly reliable data is extracted, the edge data for which the agreement has not been obtained is denied by the authentication condition described above, for example, and is not adopted as the highly reliable data, that is, training data to be a transaction target.

When obtaining the consent of use, for example, the data-holding device 30 may specify the location of the imaging subject from global positioning system (GPS) information of the imaging subject device 70, and send a push notification for presenting a privacy policy to the app if it is found that the imaging subject has entered the corresponding convenience store. If the imaging subject shows his/her consent via the push notification, the imaging subject device 70 transmits the consent of use to the data-holding device 30 and the data user device 50. Thereafter, for example, the data-holding device 30 can handle edge data obtained by imaging the corresponding imaging subject as data for which the consent has been obtained.

Note that, here, an example has been described in which the consent of use is given by the imaging subject device 70 via the app. However, the data provider may post the privacy policy as a notice at a store of a convenience store, and handle that the consent of use has been obtained in a case where the imaging subject has acquiesced, for example.

Now, description will be made with reference to FIG. 5. Note that FIG. 5 corresponds to FIG. 4, but illustration of the imaging subject device 70 is omitted for convenience of description. In FIG. 5, it is assumed that the consent of use by the imaging subject illustrated in FIG. 4 has been obtained.

As illustrated in FIG. 5, the data-holding device 30 basically transmits metadata including a data address and attribute information of data held by the data-holding device 30 to the transaction management device 10 (Step S31).

Then, the transaction management device 10 performs transaction management based on the metadata. When a desired data condition desired by the user of data is received from the data user device 50 through the market (Step S32), the transaction management device 10 executes orchestration to satisfy the condition.

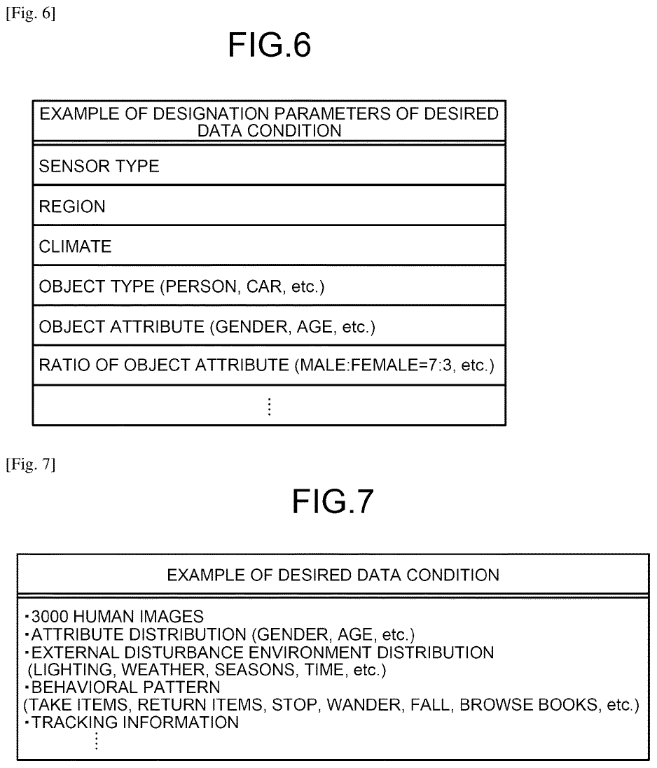

Here, an example of the desired data condition will be described. FIG. 6 is a diagram illustrating an example of designation parameters of a desired data condition. Further, FIG. 7 is a diagram illustrating an example of the desired data condition. As illustrated in FIG. 6, the designation parameter of the desired data condition includes a sensor type, a region, a climate, an object type, an object attribute, a ratio of the object attribute, and the like.

The sensor type is a parameter indicating the type, specification, and the like of the edge sensor 3. Examples of the type of the edge sensor 3 include an RGB sensor, an infrared sensor, a distance measuring sensor, a sensor capable of acquiring multiple wavelengths, an ultraviolet sensor, an event base vision sensor, and a polarization sensor. The distance measuring sensor is, for example, a time of flight (ToF) sensor, light detection and ranging (LiDAR), or the like. Examples of specifications of the edge sensor 3 include a model number, a pixel size, a data format, and power consumption. The region is a parameter indicating a region where the edge sensor 3 is provided. The weather is a parameter indicating the weather when the edge sensor 3 acquires the edge data.

The object type is a parameter indicating a type of an object such as a person or a car included (photobombed) in the edge data. The object attribute is, for example, a parameter indicating a type of an object such as gender or age in a case where the type is a person. The ratio of the object attribute is, for example, a parameter indicating a ratio of 7:3 for male:female.

Such parameters are designated, and an example of the actual desired data condition is as illustrated in FIG. 7. Note that the specific example illustrated here is merely an example, and does not limit the designation content of the actual desired data condition.

The description returns to FIG. 5. Then, the transaction management device 10 presents the arrangement information as an execution result of the orchestration, creates NFT on the basis of the approval for the arrangement information, and transmits the NFT to the data user device 50 (Step S33).

Then, the data user device 50 requests, using the NFT, training by machine learning (Step S34). In response to this request, the data-holding device 30 executes the machine learning on-premises using the highly reliable data corresponding to the data address indicated by the NFT (Step S35). Then, the data-holding device 30 transmits the trained AI model to the data user device 50 (Step S36), and the trained AI model is stored in the trained AI model DB 50a.

In addition, the history regarding the series of transactions in Step S32 to Step S36 is recorded in the transaction information management DB 12d of the transaction management device 10 and a decentralized ledger 100 of the decentralized network N.

As described above, the transaction system 1 performs the transaction management using the metadata without transferring the entity of the data held by the data-holding device 30, and executes the machine learning indirectly using the data indicated by the NFT assigned to the data address in the metadata. Therefore, the entity of the training data is managed in the data-holding device 30 on-premises, and is not distributed on the network from the data-holding device 30. Furthermore, the history regarding the transaction is managed in the decentralized ledger 100 in which high security is ensured by the blockchain. As a result, the transaction system 1 enables cross-sectional utilization of training data while further protecting personal information.

### 3. Configuration Example of Transaction Management Device

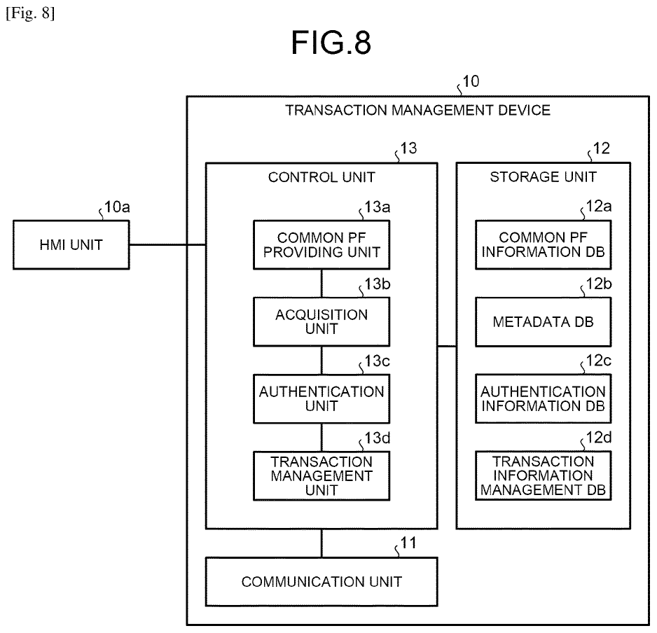

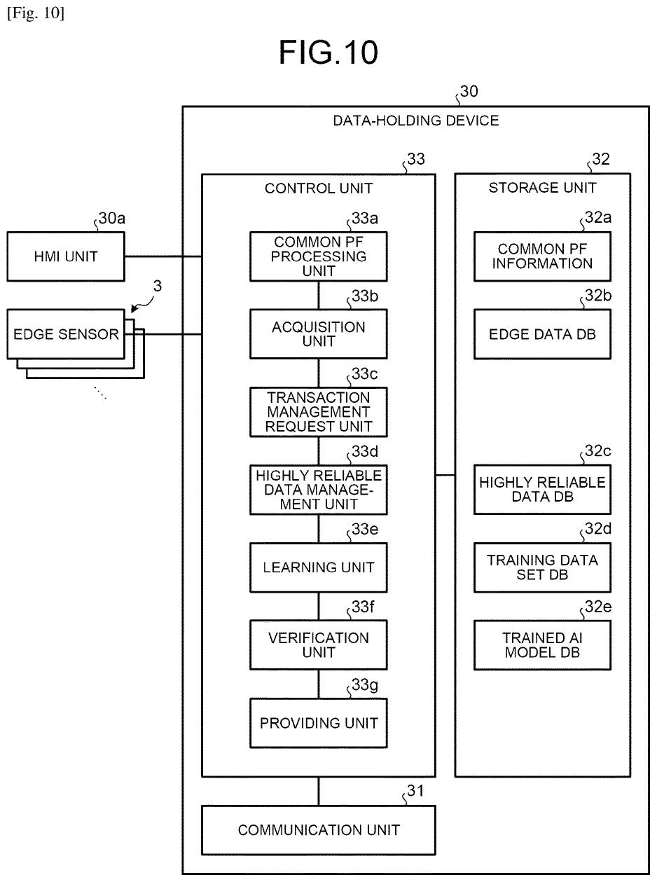

Next, a configuration example of the transaction management device 10 will be described. FIG. 8 is a block diagram illustrating a configuration example of the transaction management device 10 according to an embodiment of the present disclosure. In FIG. 8 and subsequently illustrated FIG. 10, only components necessary for describing features of the present embodiment are illustrated, and description of general components is omitted.

In other words, the constituent elements illustrated in FIGS. 8 and 10 are functionally conceptual and are not necessarily configured physically as illustrated. For example, the specific form of distribution and integration of each block is not limited to the one illustrated in the drawings, and all or a part thereof can be configured by functionally or physically distributing and integrating in any units according to various loads, usage conditions, and the like.

In the description using FIGS. 8 and 10, the description of the already described components may be simplified or omitted.

As illustrated in FIG. 8, the transaction management device 10 includes a communication unit 11, a storage unit 12, and a control unit 13. In addition, a human machine interface (HMI) unit 10a is connected to the transaction management device 10.

The HMI unit 10a is a component including an interface component related to input and output with respect to a person. The HMI unit 10a is implemented by a keyboard, a mouse, a display, a microphone, a speaker, and the like. The HMI unit 10a may include not only hardware components but also software components. The HMI unit 10a is used by an operator or the like who operates the transaction management device 10.

The communication unit 11 is implemented by, for example, a network adapter or the like. The communication unit 11 is connected to the decentralized network N, and transmits and receives information, via the decentralized network N, to and from other devices connected to the decentralized network N.

The storage unit 12 is implemented by, for example, a storage device, such as a random-access memory (RAM), a read only memory (ROM), a flash memory, or a hard disk device.

The storage unit 12 stores the common PF information DB 12a, the metadata DB 12b, the authentication information DB 12c, and the transaction information management DB 12d described with reference to FIG. 4. Although not illustrated, the storage unit 12 stores the program according to the present embodiment.

The control unit 13 controls each unit of the transaction management device 10. The control unit 13 is implemented by, for example, a central processing unit (CPU), a micro processing unit (MPU), a GPU, or the like executing the program according to the present embodiment stored in the storage unit 12 with the RAM as a work area. Furthermore, the control unit 13 is implemented by, for example, an integrated circuit, such as an application specific integrated circuit (ASIC) or a field programmable gate array (FPGA).

The control unit 13 includes a common PF providing unit 13a, an acquisition unit 13b, an authentication unit 13c, and a transaction management unit 13d. The control unit 13 uses each of these processing units to implement or execute a function and an operation of information processing described below.

The common PF providing unit 13a provides each piece of common PF information stored in the common PF information DB 12a to each device in the transaction system 1 via the communication unit 11. The acquisition unit 13b acquires the metadata of the data held by the data-holding device 30 from the data-holding device 30 via the communication unit 11 and stores the metadata in the metadata DB 12b. The metadata includes a data address and attribute information.

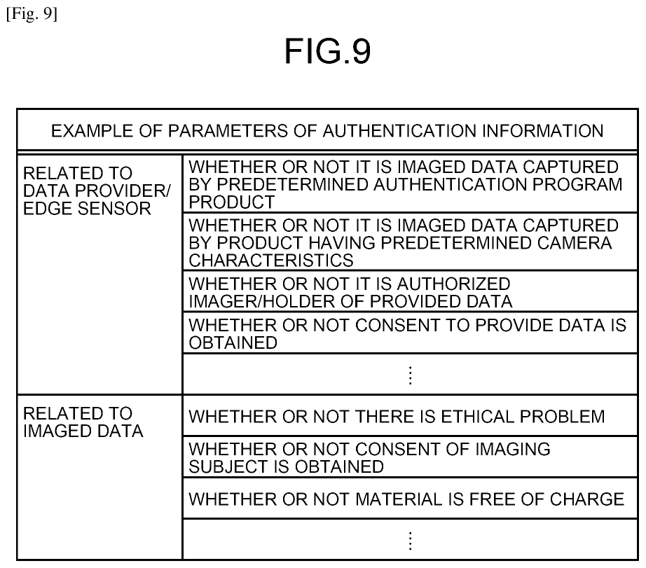

In addition, the acquisition unit 13b performs authentication process of the metadata acquired from the data-holding device 30 on the basis of the authentication information stored in the authentication information DB 12c. Here, determination details in this authentication process will be described. FIG. 9 is a diagram illustrating an example of determination details in an authentication process.

As illustrated in FIG. 9, the determination details in the authentication process are roughly divided into those related to the data provider/edge sensor 3 and those related to the imaged data.

With respect to the data provider/edge sensor 3, the authentication unit 13c determines, for example, whether or not the metadata is imaged data captured by a predetermined authentication program product on the basis of the attribute information included in the metadata. In addition, the authentication unit 13c determines whether or not the metadata is imaged data by a product having a predetermined camera characteristic. In addition, the authentication unit 13c determines whether or not an imager/holder is an authorized imager/holder of the provided data. In addition, the authentication unit 13c determines whether or not the data provider shows consent to provide the data.

Furthermore, regarding the imaged data, the authentication unit 13c determines whether or not there is an ethical problem, whether or not consent of the imaging subject is obtained, whether or not the material is free of charge, and the like on the basis of the attribute information included in the metadata.

As a result of such determination, the authentication unit 13c notifies the data-holding device 30 of the authentication result indicating the metadata corresponding to the highly reliable data suitable as the transaction target via the communication unit 11. Upon receiving this notification, the data-holding device 30 extracts the highly reliable data from the edge data DB 32b and stores the highly reliable data in the highly reliable data DB 32c. At this time, the data-holding device 30 associates the data address of the highly reliable data in the highly reliable data DB 32c with the data address of the edge data in the edge data DB 32b corresponding to the highly reliable data. In addition, the data-holding device 30 notifies the transaction management device 10 of extracting the highly reliable data.

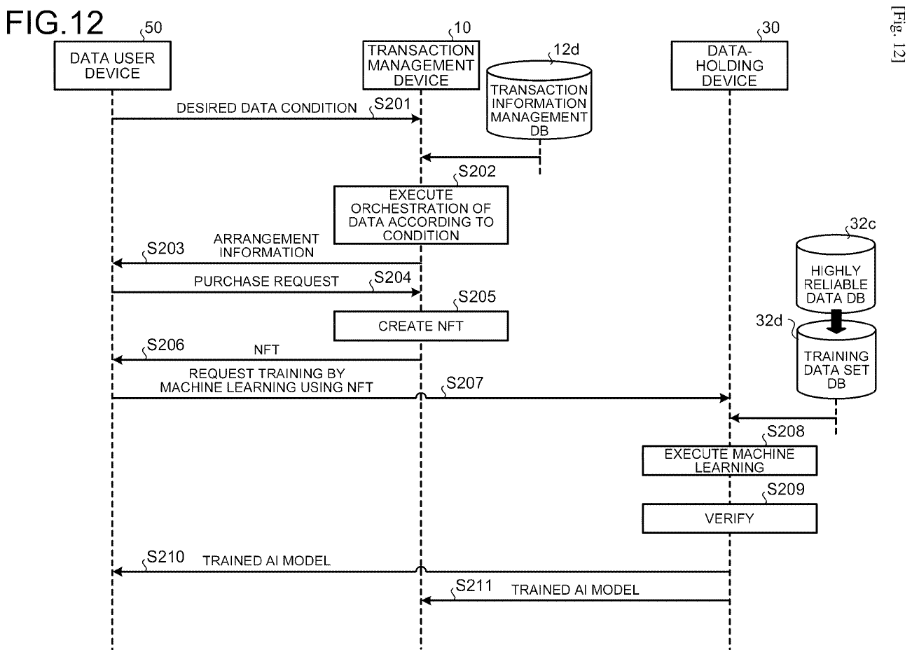

The description returns to FIG. 8. In a case where the transaction management unit 13d receives a notification indicating that the highly reliable data is extracted from the data-holding device 30, the transaction management unit 13d extracts the metadata corresponding to the highly reliable data from the metadata DB 12b and stores the extracted metadata in the transaction information management DB 12d. Then, the transaction management unit 13d performs transaction management for highly reliable data corresponding to the metadata stored in the transaction information management DB 12d as a transaction target. The contents of the transaction management will be described later with reference to a processing sequence illustrated in FIG. 12 and subsequent drawings.

### 4. Configuration Example of Data-Holding Device

Next, a configuration example of the data-holding device 30 will be described. FIG. 10 is a block diagram illustrating a configuration example of the data-holding device 30 according to an embodiment of the present disclosure.

As illustrated in FIG. 10, the data-holding device 30 includes a communication unit 31, a storage unit 32, and a control unit 33. Further, an HMI unit 30a and one or more edge sensors 3 are connected to the data-holding device 30.

The HMI unit 30a is a component similar to the HMI unit 10a described above. The HMI unit 30a is used by an operator or the like who operates the data-holding device 30. Since the edge sensor 3 has been described, description thereof is omitted here.

The communication unit 31 is a component similar to the communication unit 11 described above. Similarly to the storage unit 12 described above, the storage unit 32 is implemented by, for example, a storage device such as a RAM, a ROM, a flash memory, or a hard disk device.

In addition to the edge data DB 32b and the highly reliable data DB 32c described with reference to FIG. 4, the storage unit 32 stores common PF information 32a, a training data set DB 32d, and a trained AI model DB 32e. Although not illustrated, the storage unit 32 stores the program according to the present embodiment.

The common PF information 32a is information regarding the common PF provided from the transaction management device 10. The common PF information 32a is, for example, an AI development environment, a monetizing environment, or the like in the transaction system 1.

When the highly reliable data management unit 33d to be described later accepts a request for machine learning using NFT from the data user device 50, the training data set DB 32d stores a data set of training data extracted from the highly reliable data DB 32c by the highly reliable data management unit 33d.

The trained AI model DB 32e stores a trained AI model learned by a learning unit 33e to be described later and verified by a verification unit 33f to be also described later.

The control unit 33 controls each unit of the data-holding device 30. Similarly to the control unit 13 described above, the control unit 33 is implemented by executing the program according to the present embodiment stored in the storage unit 32 using the RAM as a work area by, for example, a CPU, an MPU, a GPU, or the like. In addition, the control unit 33 can be implemented, for example, by an integrated circuit such as an ASIC or an FPGA.

The control unit 33 includes a common PF processing unit 33a, an acquisition unit 33b, a transaction management request unit 33c, a highly reliable data management unit 33d, a learning unit 33e, a verification unit 33f, and a providing unit 33g. The control unit 33 uses each of these processing units to implement or execute a function and an operation of information processing described below.

The common PF processing unit 33a operates so that the data-holding device 30 can use the common PF in the transaction system 1 on the basis of the common PF information 32a. The common PF processing unit 33a operates as, for example, middleware.

The acquisition unit 33b acquires edge data from the edge sensor 3 via the communication unit 31 and stores the edge data in the edge data DB 32b. The transaction management request unit 33c requests the transaction management device 10 to perform transaction management of the edge data stored in the edge data DB 32b via the communication unit 31. In addition, the transaction management request unit 33c receives a notification of an authentication result from the transaction management device 10 in response to the request.

The highly reliable data management unit 33d extracts highly reliable data from the edge data DB 32b on the basis of the authentication result received by the transaction management request unit 33c and stores the highly reliable data in the highly reliable data DB 32c. In addition, the highly reliable data management unit 33d notifies the transaction management device 10 of the processing result obtained by extracting the highly reliable data via the communication unit 31.

Further, when receiving a request for machine learning using the NFT from the data user device 50 via the communication unit 31, the highly reliable data management unit 33d extracts highly reliable data corresponding to a data address indicated by the NFT from the highly reliable data DB 32c and stores the highly reliable data in the training data set DB 32d.

The learning unit 33e executes machine learning using the training data set stored in the training data set DB 32d. The verification unit 33f verifies the accuracy of the trained AI model that is a result of the machine learning executed by the learning unit 33e.

For example, the verification unit 33f performs verification using the training data set of the training data set DB 32d as a recognition target. Alternatively, the verification unit 33f may extract a data set of any image data from the edge data DB 32b and the highly reliable data DB 32c, and perform verification using this data set as a recognition target.

In a case where the verified trained AI model has recognition accuracy of a certain level or more, the verification unit 33f stores the trained AI model in the trained AI model DB 32e. The providing unit 33g provides the trained AI model stored in the trained AI model DB 32e, via the communication unit 31, to the data user device 50 that is a request source of the machine learning.

### 5. Processing Sequence Executed by Transaction System

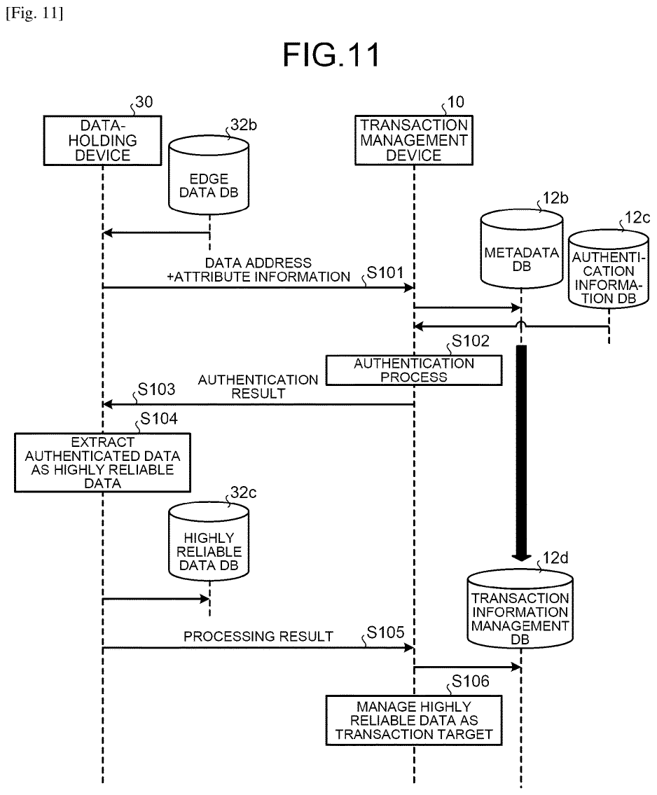

Next, a processing sequence executed by the transaction system 1 will be described with reference to FIGS. 11 to 17. In the following description, it is assumed that the consent of use described with reference to FIG. 4 has already been obtained.

### 5-1. Processing Sequence from Transaction Management Request to Transaction Management Start

FIG. 11 is a diagram illustrating a processing sequence from a transaction management request to a transaction management start. As illustrated in FIG. 11, first, the data-holding device 30 transmits metadata including at least a data address and attribute information of each edge data of the edge data DB 32b to the transaction management device 10 as a transaction management request (Step S101).

The transaction management device 10 stores the received metadata in the metadata DB 12b, and executes authentication process for each metadata on the basis of the authentication information in the authentication information DB 12c (Step S102). Then, the transaction management device 10 transmits the authentication result to the data-holding device 30 (Step S103).

The data-holding device 30 extracts the authenticated data as the highly reliable data on the basis of the received authentication result (Step S104), and stores the extracted data in the highly reliable data DB 32c. In addition, the data-holding device 30 transmits the processing result to the transaction management device 10 (Step S105).

Then, the data-holding device 30 receives the processing result, extracts the metadata corresponding to the highly reliable data from the metadata DB 12b, stores the extracted metadata in the transaction information management DB 12d, and manages the highly reliable data as a transaction target (Step S106).

### 5-2. Processing Sequence from Presentation of Desired Data Condition to Provision of Trained AI Model

Next, FIG. 12 is a diagram illustrating a processing sequence from presentation of a desired data condition to provision of a trained AI model. As illustrated in FIG. 12, first, the data user device 50 presents the desired data condition to the transaction management device 10 through the market (Step S201).

Then, the transaction management device 10 that has received this condition executes orchestration of data according to the condition from among the highly reliable data as the transaction target on the basis of the metadata of the transaction information management DB 12d (Step S202). Then, the transaction management device 10 transmits the arrangement information that is an execution result of the orchestration to the data user device 50 (Step S203).

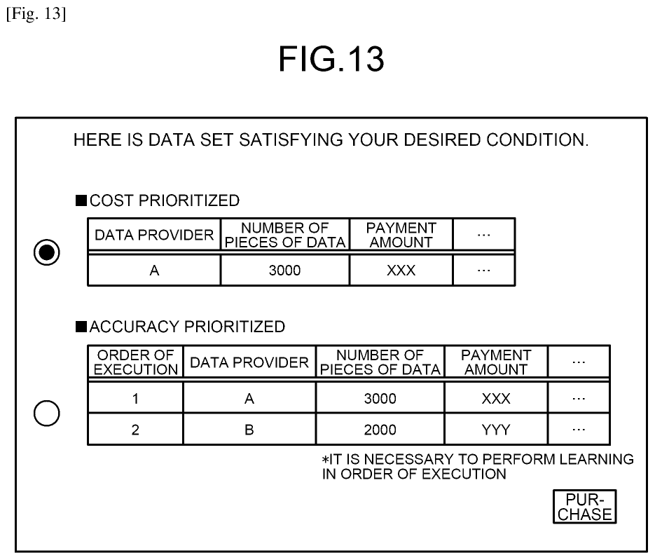

The data user device 50 presents the received arrangement information to the user of data via, for example, a GUI screen, and receives an intention to purchase via the GUI screen as well. Note that an example of the GUI screen will be illustrated later in FIG. 13.

Then, in a case where the user of data has determined to purchase the arrangement information presented, the data user device 50 transmits a purchase request to the transaction management device 10 (Step S204). Upon receiving the purchase request, the transaction management device 10 creates NFT on the data address of the metadata corresponding to the arrangement information (Step S205). Then, the transaction management device 10 transmits the NFT data address to the data user device 50 (Step S206).

Then, the data user device 50 requests training by machine learning using the NFT from the data-holding device 30 (Step S207). Then, the data-holding device 30 extracts the highly reliable data indicated by the NFT from the highly reliable data DB 32c, stores the highly reliable data as the training data set in the training data set DB 32d, and executes the machine learning using the highly reliable data as the training data set (Step S208).

Then, the data-holding device 30 verifies the trained AI model that is the execution result of Step S208 (Step S209), and then provides the trained AI model after verification to the data user device 50 (Step S210). At the same time, the data-holding device 30 may transmit the trained AI model to the transaction management device 10 so as to be a transaction target in the market (Step S211).

Here, an example of a GUI screen that presents the above-described arrangement information will be described. FIG. 13 is a diagram illustrating an example of a GUI screen that presents arrangement information.

The transaction management device 10 presents arrangement information that is an execution result of orchestration as a GUI screen as illustrated in FIG. 13. FIG. 13 illustrates an example in which the transaction management device 10 presents a plurality of pieces of arrangement information.

As illustrated in FIG. 13, the transaction management device 10 executes orchestration under some conditions according to prioritized contents such as “cost prioritized” and “accuracy prioritized”, and presents arrangement information including a result of the orchestration.

Here, as illustrated in FIG. 13, when the user of data selects “cost prioritized” and executes “purchase”, the data address indicated by each piece of metadata corresponding to the arrangement information with cost prioritized is subjected to NFT.

Note that, as described as an example of “accuracy prioritized”, the transaction management device 10 may present arrangement information including a combination of data sets across a plurality of data providers (that is, the plurality of data-holding devices 30), for example. Furthermore, at this time, as illustrated as “*It is necessary to perform learning in order of execution” in FIG. 13, guidance information and the like for the case of a plurality of data providers may be presented. Next, a processing sequence for the case of executing machine learning sequentially across a plurality of data providers will be described.

### 5-3. Processing Sequence for Case of Executing Machine Learning Sequentially Across Plurality of Data Providers

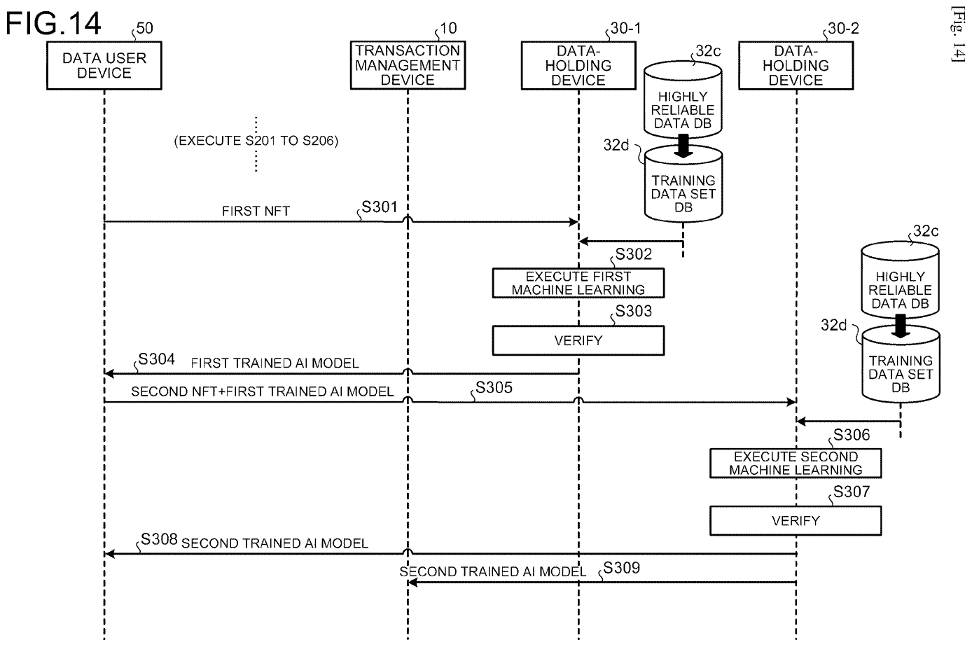

FIG. 14 is a diagram illustrating a processing sequence for the case of executing machine learning sequentially across a plurality of data providers. FIG. 14 illustrates a processing sequence after execution of Step S201 to Step S206 in FIG. 12.

Note that, in Step S203, arrangement information across the first and second data providers is presented, and it is assumed that the user of data purchased a data set of the arrangement information. Then, in Step S206, the user of data obtains the first NFT corresponding to the first data provider and the second NFT corresponding to the second data provider.

In this case, the data user device 50 first requests, by using the first NFT, a data-holding device 30-1 to perform training by the first machine learning (Step S301). Then, the data-holding device 30-1 extracts the highly reliable data indicated by the first NFT from the highly reliable data DB 32c, stores the highly reliable data as the training data set in the training data set DB 32d, and executes the first machine learning using the highly reliable data as the training data set (Step S302).

Then, the data-holding device 30-1 verifies the first trained AI model that is the execution result of Step S302 (Step S303), and then provides the first trained AI model after verification to the data user device 50 (Step S304).

Next, the data user device 50 requests, by using the second NFT and the first trained AI model, a data-holding device 30-2 to perform training by the second machine learning (Step S305). Then, the data-holding device 30-2 extracts the highly reliable data indicated by the second NFT from the highly reliable data DB 32c, stores the highly reliable data as the training data set in the training data set DB 32d, and executes the second machine learning to reinforce the first trained AI model using the highly reliable data as the training data set (Step S306).

Then, the data-holding device 30-2 verifies the second trained AI model that is the execution result of Step S306 (Step S307), and then provides the second trained AI model after verification to the data user device 50 (Step S308). At the same time, the data-holding device 30 transmits the second trained AI model to the transaction management device 10 so as to be a transaction target in the market (Step S309).

### 5-4. Processing Sequence for Case of Obtaining Confirmation of Data-Holding Device

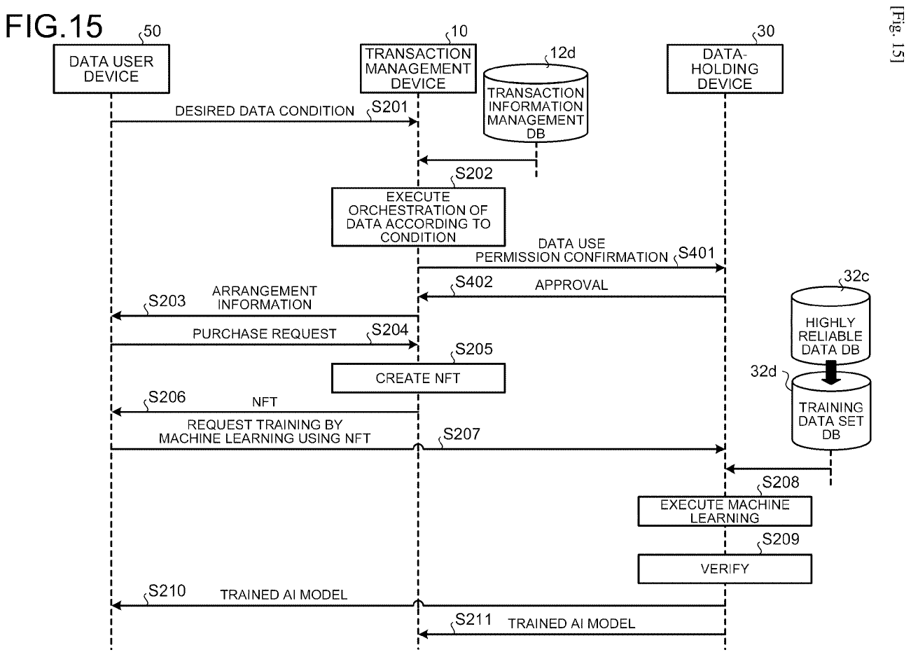

Next, a processing sequence in a case of obtaining confirmation of the data-holding device 30 will be described. FIG. 15 is a diagram illustrating a processing sequence in a case of obtaining confirmation of the data-holding device 30.

Note that FIG. 15 corresponds to FIG. 12, and here, points different from FIG. 12 will be mainly described. The example of FIG. 15 is different from that of FIG. 12 in that the transaction management device 10 confirms the data-holding device 30 after execution of the orchestration in Step S202 and before presentation of the arrangement information in Step S203.

In the case of FIG. 15, after executing Step S202, the transaction management device 10 transmits a data use permission confirmation for requesting the data use permission from the data-holding device 30 (Step S401). Then, in a case where the approval of the confirmation is obtained from the data-holding device 30 (Step S402), the transaction management device 10 executes Step S203 of presenting the arrangement information to the data user device 50.

This result in the safe data use with the consent of the data-holding device 30. Note that, in a case where the approval is not obtained from the data-holding device 30, the transaction management device 10 may execute orchestration again, generate new arrangement information, and confirm the data-holding device 30 again.

### 5-5. Processing Sequence for Case of Performing Retraining based on Improvement Request from End User

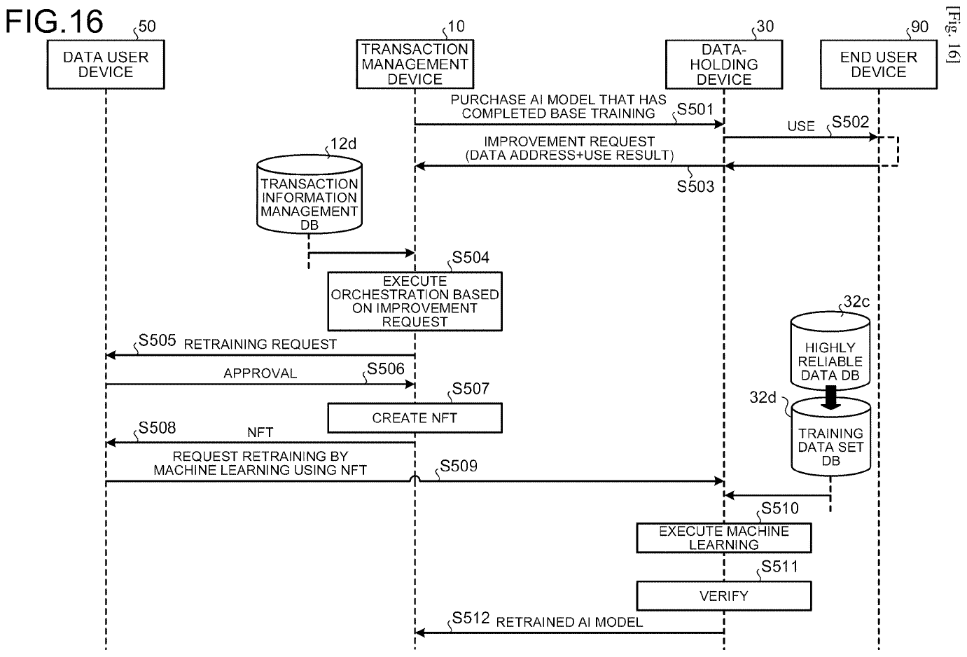

Next, a processing sequence in a case of performing retraining based on an improvement request from an end user of a data provider. FIG. 16 is a diagram illustrating a processing sequence in a case of performing retraining based on an improvement request from an end user.

As illustrated in FIG. 16, first, it is assumed that the data-holding device 30 has purchased an AI model that has completed base training as a base from the transaction management device 10 (Step S501), and the end user is using this AI model that has completed base training by an end user device 90 which is a terminal device of the end user (Step S502).

Among them, it is assumed that the end user finds edge data with poor recognition accuracy when using the AI model that has completed base training. In this case, as illustrated in FIG. 16, the end user device 90 raises an improvement request to the transaction management device 10 via, for example, the data-holding device 30 (Step S503). The improvement request is, for example, a data address and a use result (AI recognition result) of edge data with no accuracy mentioned above.

Then, the transaction management device 10 executes orchestration based on the improvement request (Step S504), and requests the data user device 50 to perform retraining on the basis of the arrangement information as the execution result (Step S505).

Then, when the data user device 50 approves the request (Step S506), the transaction management device 10 creates NFT on the data address of the metadata corresponding to the arrangement information (Step S507). Then, the transaction management device 10 transmits the NFT data address to the data user device 50 (Step S508).

Then, the data user device 50 requests retraining by machine learning from the data-holding device 30 using the NFT (Step S509). Then, the data-holding device 30 extracts the highly reliable data indicated by the NFT from the highly reliable data DB 32c, stores the highly reliable data as the training data set in the training data set DB 32d, and executes the machine learning using the highly reliable data as the training data set (Step S510).

Then, the data-holding device 30 verifies the retrained AI which is the execution result of Step S510 (Step S511), and transmits the retrained AI model after the verification to the transaction management device 10 so as to be a new transaction target in the market (Step S512).

Note that, in the case of the example of FIG. 16, the data-holding device 30 pays a request fee, which is a compensation for the improvement request in Step S503, to the transaction management device 10 with, for example, a digital token. The transaction management device 10 pays a retraining request fee obtained by subtracting a transaction fee including compensation for orchestration from the request fee to the data user device 50 with a digital token or the like in Step S506. Note that this payment may be made later after retraining is performed.

If the payment is made later after the retraining, the transaction management device 10 may present the retraining request in Step S505 to the plurality of data user devices 50 to cause the plurality of users of data to compete with each other. In this case, a reward may be paid to a user of data who can release the retrained AI model earliest or can develop the retrained AI model with the highest recognition accuracy.

This makes it possible to improve the trained AI model with high quality in response to the improvement request from the end user.

### 5-6. Processing Sequence for Case of Trading Direct Right to Use of Data

By the way, heretofore, the case where the indirect right to use of data is traded without setting the entity of data as a transaction target has been described as an example, but it is also possible to trade the direct right to use of data with the entity of data as a transaction target.

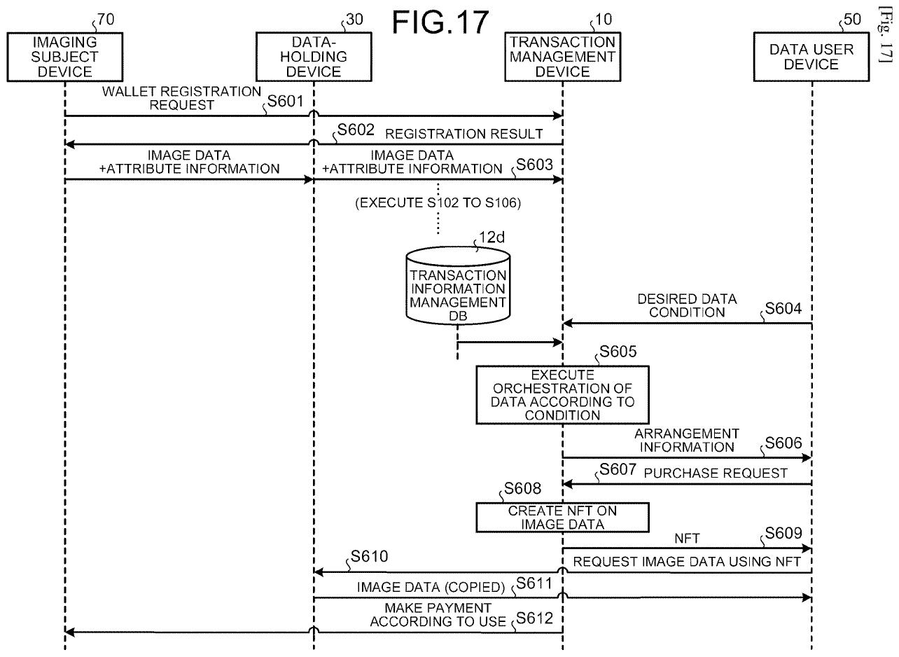

Next, a processing sequence in this case will be described. FIG. 17 is a diagram illustrating a processing sequence in a case of trading a direct right to use of data. Note that, in the example of FIG. 17, a case where the transaction target is not the edge data held by the data-holding device 30 but, for example, the image data held by the imaging subject device 70 used by the imaging subject will be described as an example.

When the image data held by the imaging subject is registered as a transaction target in the transaction system 1 and used by a user of data, the subject can receive a reward as a usage fee each time.

As a preliminary preparation, as illustrated in FIG. 17, the imaging subject device 70 transmits a wallet registration request to the transaction management device 10 via an app or the like (Step S601). The wallet referred to herein is so-called a deposit/ withdrawal account for the imaging subject in the transaction system 1.

In response to the request in Step S601, the transaction management device 10 opens and registers a wallet of the imaging subject and notifies the imaging subject device 70 of the registration result (Step S602). This is the preliminary preparation.

Then, the imaging subject device 70 transmits image data (entity) held by the imaging subject device 70 itself and attribute information thereof as a transaction management request to the transaction management device 10 via the data-holding device 30 (Step S603).

Then, the transaction management device 10 executes Step S102 to Step S106 illustrated in FIG. 11 in response to the transaction management request. As a result, the highly reliable data that has cleared the authentication condition among the image data from the imaging subject device 70 becomes a transaction target.

Then, the data user device 50 presents the desired data condition to the transaction management device 10 through the market (Step S604).

Then, the transaction management device 10 that has received this condition executes orchestration of data according to the condition from among the highly reliable data as the transaction target (Step S605). Then, the transaction management device 10 transmits arrangement information that is an execution result of the orchestration to the data user device 50 (Step S606).

Then, in a case where the user of data has determined to purchase the arrangement information presented, the data user device 50 transmits a purchase request to the transaction management device 10 (Step S607). Upon receiving the purchase request, the transaction management device 10 creates NFT on the image data corresponding to the arrangement information (Step S608). Then, the transaction management device 10 transmits the NFT to the data user device 50 (Step S609).

Then, the data user device 50 requests image data from the data-holding device 30 using the NFT (Step S610). Then, the data-holding device 30 extracts the highly reliable data indicated by the NFT from the highly reliable data DB 32c, and provides the data user device 50 with the extracted highly reliable data as copied image data (Step S611). The data user device 50 performs, for example, machine learning or the like by the data user device 50 itself by directly using the image data.

Note that, every time the image data from the imaging subject device 70 is used by the user of data, the transaction management device 10 makes a payment to the wallet of the imaging subject with a digital token or the like according to use (Step S612).

As a result, it is possible to perform a transaction using, for example, image data held by the imaging subject, which is not the edge data from the edge sensor 3, as a transaction target. Note that, in a case where an entity of image data is managed as a transaction target, there is a possibility that image data having a large size cannot be stored in a blockchain, and thus, an interplanetary filesystem (IPFS) or the like may be used instead of the blockchain.

### 6. Modification

Among the processing described in the embodiments of the present disclosure described above, all or a part of the processing, described as automatic processing, can be performed manually, or all or a part of the processing, described as manual processing, can be performed automatically by a known method. In addition, the processing procedures, specific names, and information including various data and parameters indicated in the document and the drawings can be arbitrarily changed unless otherwise specified. For example, various types of information illustrated in the drawings are not limited to the illustrated information.

Furthermore, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in any units according to various loads, usage conditions, and the like.

For example, the authentication unit 13c included in the transaction management device 10 may be provided as an authentication device independent of the transaction management device 10.

Furthermore, for example, the highly reliable data management unit 33d included in the data-holding device 30 may be provided as a highly reliable data management device independent from the data-holding device 30 together with the highly reliable data DB 32c. In this case, the entity of the data held by the data-holding device 30 is distributed among different devices, but it is considered that there is little risk that the entity of the data spreads from the users of data by setting the indirect right to use of the data as the transaction target. In addition, since the entity of the highly reliable data is managed by the data-holding device 30 and the highly reliable data management device, so-called mirroring of the highly reliable data can be performed, and high availability can be secured.

Furthermore, the above-described embodiments of the present disclosure can be appropriately combined to the extent that the processing contents do not contradict each other. Furthermore, the order of each step illustrated in the sequence diagrams or the flowcharts of the present embodiment can be changed as appropriate.

### 7. Hardware Configuration

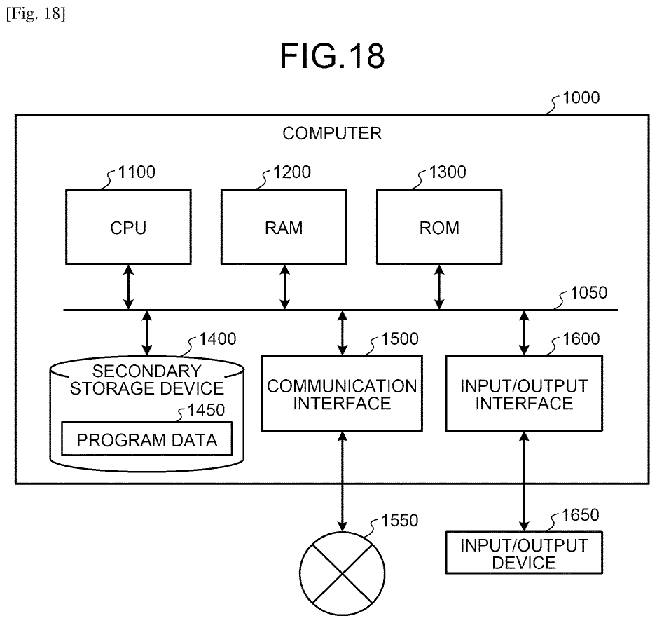

Furthermore, the transaction management device 10, the data-holding device 30, the data user device 50, and the imaging subject device 70 according to the embodiment of the present disclosure described above are implemented by a computer 1000 having a configuration as illustrated in FIG. 18, for example. The transaction management device 10 will be described as an example. FIG. 18 is a hardware configuration diagram illustrating an example of the computer 1000 that implements functions of the transaction management device 10. The computer 1000 includes a CPU 1100, a RAM 1200, a ROM 1300, a secondary storage device 1400, a communication interface 1500, and an input/output interface 1600. Each unit of the computer 1000 is connected by a bus 1050.

The CPU 1100 operates on the basis of a program stored in the ROM 1300 or the secondary storage device 1400, and controls each unit. For example, the CPU 1100 de-compresses a program stored in the ROM 1300 or the secondary storage device 1400 in the RAM 1200, and executes processing corresponding to various programs.

The ROM 1300 stores a boot program such as a basic input output system (BIOS) executed by the CPU 1100 when the computer 1000 is started, a program depending on hardware of the computer 1000, and the like.

The secondary storage device 1400 is a computer-readable recording medium that non-transiently records a program executed by the CPU 1100, data used by the program, and the like. Specifically, the secondary storage device 1400 is a recording medium that records the program according to the present embodiment.

The communication interface 1500 is an interface for the computer 1000 to connect to an external network 1550. For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the transaction management device 10, the CPU 1100 of the computer 1000 implements the functions of the control unit 13 by executing a program loaded on the RAM 1200. In addition, the secondary storage device 1400 stores a program according to the present disclosure and data in the storage unit 12. Note that the CPU 1100 reads program data 1450 from the secondary storage device 1400 and executes the program data, but as another example, these programs may be acquired from another device via the external network 1550.

### 8. Conclusion

As described above, according to an embodiment of the present disclosure, the transaction system 1 (corresponds to an example of the “information processing system”) is an information processing system that transacts training data used for machine learning, and includes the data-holding device 30 (corresponds to an example of the “data-holding unit”) to store the training data, and the transaction management device 10 (corresponds to an example of the “transaction management unit”) to hold, in the decentralized network N, transaction information of the training data based on metadata indicating a storage destination of the training data stored in the data-holding device 30 and attribute information. In addition, the transaction management device 10 imparts non-replaceability in the decentralized network N to the metadata according to a request when the request of the user of data (corresponds to an example of the “user”) who desires to use training data is accepted, and provides the user of data with a right to use of training data corresponding to the metadata to which the non-replaceability is imparted. As a result, it is possible to cross-sectional utilize training data while further protecting personal information.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Furthermore, the effects of the embodiments described in the present specification are merely examples and are not limited, and other effects may be provided.

Note that the present technology can also have the following configurations.
(1)

An information processing system, comprising:
first circuitry configured to
   receive a request for target data from a terminal device, the request for the target data including parameters specifying one or more desired data conditions,
   in response to the request for target data, generate, from a first database storing metadata corresponding to authenticated training data, options for a training data set based on the target data,
   transmit the options for the training data set to the terminal device,
   receive a request from the terminal device to access a training data set from the options for the training data set,
   in response to the request to access the training data set, create a non-fungible token for a data address of the metadata corresponding to the training data set,
   transmit the non-fungible token to the terminal device, and
   receive, from a server, a trained machine learning model based on the training data set indicated by the non-fungible token.
(2)

The information processing system of (1), further comprising:
the server, wherein the server includes second circuitry configured to
   receive a request from the terminal device using the non-fungible token,
   extract, from a second database, the training data set indicated by the non-fungible token, and
   store, in a third database, the training data set.
(3)

The information processing system of (2), wherein the second circuitry is further configured to
train the machine learning model based on the training data set indicated by the non-fungible token.
(4)

The information processing system of (3), wherein the second circuitry is further configured to
verify a recognition accuracy of the trained machine learning model.
(5)

The information processing system of (4), wherein the second circuitry is further configured to
in a case that the recognition accuracy is above a predetermined threshold, transmit the trained machined learning model to the terminal device using the non-fungible token.
(6)

The information processing system of (1), wherein only metadata is stored in the first database.
(7)

The information processing system of (6), wherein the metadata includes a data address for a data storage destination and attribute information.
(8)

The information processing system of (1), wherein the non-fungible token provides a right to an indirect use of the training data set.
(9)

The information processing system of (1), wherein the first processing circuitry is further configured to
store, in a decentralized network, transaction information corresponding to a transaction for the training data set.
(10)

The information processing system of (1), further comprising:
a plurality of servers each having training data,
wherein a first server of the plurality of servers includes third circuitry configured to
   train a first machine learning model using a training data set indicated by the non-fungible token,
wherein a second server of the plurality of servers includes fourth circuitry configured to
   train a second machine learning model to reinforce the first trained machine learning model,
wherein each subsequent server used to reinforce the first machine learning model improves a recognition accuracy of the first machine learning model.
(11)

One or more computer readable media including computer program instructions which, when executed by one or more computing devices, cause the one or more computing devices to:
receive a request for target data from a terminal device, the request for the target data including parameters specifying one or more desired data conditions,
in response to the request for target data, generate, from a first database storing metadata corresponding to authenticated training data, options for a training data set based on the target data,
transmit the options for the training data set to the terminal device,
receive a request from the terminal device to access a training data set from the options for the training data set,
in response to the request to access the training data set, create a non-fungible token for a data address of the metadata corresponding to the training data set,
transmit the non-fungible token to the terminal device, and
receive, from a server, a trained machine learning model based on the training data set indicated by the non-fungible token.
(12)

The one or more computer readable media of (11), further configured to
receive a request from the terminal device using the non-fungible token,
extract, from a second database, the training data set indicated by the non-fungible token, and
store, in a third database, the training data set.
(13)

The one or more computer readable media of (12), further configured to
train the machine learning model based on the training data set indicated by the non-fungible token.
(14)

The one or more computer readable media of (13), further configured to
verify a recognition accuracy of the trained machine learning model.
(15)

The one or more computer readable media of (14), further configured to
in a case that the recognition accuracy is above a predetermined threshold, transmit the trained machined learning model to the terminal device using the non-fungible token.
(16)

The one or more computer readable media of (11), wherein the metadata includes a data address for a data storage destination and attribute information.
(17)

The one or more computer readable media of (11), wherein the non-fungible token provides a right to an indirect use of the training data set.
(18)

The one or more computer readable media of (11), further configured to
store, in a decentralized network, transaction information corresponding to a transaction for the training data set.
(19)

The one or more computer readable media of (11), further configured to
train a first machine learning model using a training data set indicated by the non-fungible token, and
train a second machine learning model to reinforce the first trained machine learning model,
wherein each subsequent server used to reinforce the first machine learning model improves a recognition accuracy of the first machine learning model.
(20)

An information processing system, comprising:
a terminal device;
a transaction server;
one or more data-holding servers; and
a plurality of databases;
wherein the transaction server includes circuitry configured to
   receive a request for target data from the terminal device, the request for the target data including parameters specifying one or more desired data conditions,
   in response to the request for target data, generate, from a first database of the plurality of databases storing metadata corresponding to authenticated training data, options for a training data set based on the target data,
   transmit the options for the training data set to the terminal device,
   receive a request from the terminal device to access a training data set from the options for the training data set,
   in response to the request to access the training data set, create a non-fungible token for a data address of the metadata corresponding to the training data set,
   transmit the non-fungible token to the terminal device, and
   receive, from a data-holding server of the one or more data holding servers, a trained machine learning model based on the training data set indicated by the non-fungible token.

### REFERENCE SIGNS LIST

1 Transaction system
3 Edge sensor
10 Transaction management device
11 Communication unit
12 Storage unit
12a Common PF information DB
12b Metadata DB
12c Authentication information DB
12d Transaction information management DB
13 Control unit
13a Common PF providing unit
13b Acquisition unit
13c Authentication unit
13d Transaction management unit
30 Data-holding device
31 Communication unit
32 Storage unit
32a Common PF information
32b Edge data DB
32c Highly reliable data DB
32d Training data set DB
32e Trained AI model DB
33 Control unit
33a Common PF processing unit
33b Acquisition unit
33c Transaction management request unit
33d Highly reliable data management unit
33e Learning unit
33f Verification unit
33g Providing unit
50 Data user device
70 Imaging subject device
90 End user device
100 Decentralized ledger
N Decentralized network

1. An information processing system, comprising:
first circuitry configured to
receive a request for target data from a terminal device, the request for the target data including parameters specifying one or more desired data conditions,
in response to the request for target data, generate, from a first database storing metadata corresponding to authenticated training data, options for a training data set based on the target data,
transmit the options for the training data set to the terminal device,
receive a request from the terminal device to access a training data set from the options for the training data set,
in response to the request to access the training data set, create a non-fungible token for a data address of the metadata corresponding to the training data set,
transmit the non-fungible token to the terminal device, and
receive, from a server, a trained machine learning model based on the training data set indicated by the non-fungible token.

2. The information processing system of claim 1, further comprising:
the server, wherein the server includes second circuitry configured to
receive a request from the terminal device using the non-fungible token,
extract, from a second database, the training data set indicated by the non-fungible token, and
store, in a third database, the training data set.

3. The information processing system of claim 2, wherein the second circuitry is further configured to
train the machine learning model based on the training data set indicated by the non-fungible token.

4. The information processing system of claim 3, wherein the second circuitry is further configured to
verify a recognition accuracy of the trained machine learning model.

5. The information processing system of claim 4, wherein the second circuitry is further configured to
in a case that the recognition accuracy is above a predetermined threshold, transmit the trained machined learning model to the terminal device using the non-fungible token.

6. The information processing system of claim 1, wherein only metadata is stored in the first database.

7. The information processing system of claim 6, wherein the metadata includes a data address for a data storage destination and attribute information.

8. The information processing system of claim 1, wherein the non-fungible token provides a right to an indirect use of the training data set.

9. The information processing system of claim 1, wherein the first processing circuitry is further configured to
store, in a decentralized network, transaction information corresponding to a transaction for the training data set.

10. The information processing system of claim 1, further comprising:
a plurality of servers each having training data,
wherein a first server of the plurality of servers includes third circuitry configured to
train a first machine learning model using a training data set indicated by the non-fungible token,
wherein a second server of the plurality of servers includes fourth circuitry configured to
train a second machine learning model to reinforce the first trained machine learning model,
wherein each subsequent server used to reinforce the first machine learning model improves a recognition accuracy of the first machine learning model.

11. One or more computer readable media including computer program instructions which, when executed by one or more computing devices, cause the one or more computing devices to:
receive a request for target data from a terminal device, the request for the target data including parameters specifying one or more desired data conditions,
in response to the request for target data, generate, from a first database storing metadata corresponding to authenticated training data, options for a training data set based on the target data,
transmit the options for the training data set to the terminal device,
receive a request from the terminal device to access a training data set from the options for the training data set,
in response to the request to access the training data set, create a non-fungible token for a data address of the metadata corresponding to the training data set,
transmit the non-fungible token to the terminal device, and
receive, from a server, a trained machine learning model based on the training data set indicated by the non-fungible token.

12. The one or more computer readable media of claim 11, further configured to
receive a request from the terminal device using the non-fungible token,
extract, from a second database, the training data set indicated by the non-fungible token, and
store, in a third database, the training data set.

13. The one or more computer readable media of claim 12, further configured to
train the machine learning model based on the training data set indicated by the non-fungible token.

14. The one or more computer readable media of claim 13, further configured to
verify a recognition accuracy of the trained machine learning model.

15. The one or more computer readable media of claim 14, further configured to
in a case that the recognition accuracy is above a predetermined threshold, transmit the trained machined learning model to the terminal device using the non-fungible token.

16. The one or more computer readable media of claim 11, wherein the metadata includes a data address for a data storage destination and attribute information.

17. The one or more computer readable media of claim 11, wherein the non-fungible token provides a right to an indirect use of the training data set.

18. The one or more computer readable media of claim 11, further configured to
store, in a decentralized network, transaction information corresponding to a transaction for the training data set.

19. The one or more computer readable media of claim 11, further configured to
train a first machine learning model using a training data set indicated by the non-fungible token, and
train a second machine learning model to reinforce the first trained machine learning model,
wherein each subsequent server used to reinforce the first machine learning model improves a recognition accuracy of the first machine learning model.

20. An information processing system, comprising:
a terminal device;
a transaction server;
one or more data-holding servers; and
a plurality of databases;
wherein the transaction server includes circuitry configured to
receive a request for target data from the terminal device, the request for the target data including parameters specifying one or more desired data conditions,
in response to the request for target data, generate, from a first database of the plurality of databases storing metadata corresponding to authenticated training data, options for a training data set based on the target data,
transmit the options for the training data set to the terminal device,
receive a request from the terminal device to access a training data set from the options for the training data set,
in response to the request to access the training data set, create a non-fungible token for a data address of the metadata corresponding to the training data set,
transmit the non-fungible token to the terminal device, and
receive, from a data-holding server of the one or more data holding servers, a trained machine learning model based on the training data set indicated by the non-fungible token.
